(19) United States
(12) Patent Application Publication
(10) Pub. No.: US 2024/0098565 A1
(43) Pub. Date: Mar. 21, 2024

(54) RECONFIGURING CONTROL PLANE IN OPEN RADIO ACCESS NETWORKS

(71) Applicant: International Business Machines Corporation, Armonk, NY (US)

(72) Inventors: Maja Curic, Munich (DE); Sagar Tayal, Ambala City (IN)

(21) Appl. No.: 17/932,725

(22) Filed: Sep. 16, 2022

(51) Int. Cl. H04W 28/08; H04W 28/02

(52) U.S. Cl. CPC H04W 28/0804; H04W 28/0215; H04W 28/0263; H04W 28/0958

(57) ABSTRACT

A computer-implemented method for dynamically reconfiguring a control plane of a radio access network. The computer-implemented method includes generating a self-awareness matrix of a radio access network (RAN) that comprises a plurality of E2 nodes, the self-awareness matrix comprises a plurality of records for each respective E2 node from the plurality of E2 nodes, a first record corresponding to a first E2 node comprises, for the first E2 node, one or more attributes of the control plane of the RAN, the first E2 node being assigned to a first Near-Real-Time RAN Intelligent Controller (near-RT RIC). The method further includes, in response to the first record satisfying a predetermined condition based on the one or more attributes of the control plane reconfiguring the control plane of the RAN.

### BACKGROUND

The present invention relates to computer technology, programmable networks, particularly to programmable radio access networks (RANs) that use the open-RAN (O-RAN) network specifications.

A RAN is a portion of a telecommunication system, typically, that connects a user equipment (UE) device, such as a mobile phone, a computer, or any remotely controlled machine and the core network (CN) of the telecommunication system. The RAN functionality is generally provided by hardware and/or software residing in base station in proximity to cell site. O-RAN, refers to a disaggregated approach to deploying a RAN by using open and/or interoperable protocols and interfaces, which allows for increased flexibility over traditional RAN systems. O-RAN can be implemented with vendor-neutral hardware and software-defined technology based on open interfaces and industry-developed standards.

### SUMMARY

According to one or more embodiments of the present invention, a computer-implemented method for dynamically reconfiguring a control plane of a radio access network. The computer-implemented method includes generating a self-awareness matrix of a radio access network (RAN) that comprises a plurality of E2 nodes, the self-awareness matrix comprises a plurality of records for each respective E2 node from the plurality of E2 nodes, a first record corresponding to a first E2 node comprises, for the first E2 node, one or more attributes of the control plane of the RAN, the first E2 node being assigned to a first Near-Real-Time RAN Intelligent Controller (near-RT RIC). The method further includes, in response to the first record satisfying a predetermined condition based on the one or more attributes of the control plane reconfiguring the control plane of the RAN.

In one or more embodiments of the present invention, the one or more attributes of the control plane comprise a transaction load, a latency response, and a distance from a controlling near-RT RIC.

In one or more embodiments of the present invention, the first record comprises one or more attributes of a user plane of the RAN for the first E2 node. The one or more attributes of the user plane of the RAN comprise a performance key performance index, and a fault data.

In one or more embodiments of the present invention, reconfiguring the control plane comprises updating at least one of the E2 nodes by reassigning a near-RT RIC associated with the at least one of the E2 nodes.

In one or more embodiments of the present invention, reconfiguring the control plane comprises migrating the first near-RT RIC.

In one or more embodiments of the present invention, reconfiguring the control plane comprises instantiating a new near-RT RIC.

In one or more embodiments of the present invention, reconfiguring the control plane comprises changing one or more control units (CUs) and/or one or more distributed units (DUs) associated with the first near-RT RIC.

According to one or more embodiments of the present invention, a system includes a non-real-time radio access network intelligent controller (non-RT RIC) of a radio access network (RAN). The system further includes multiple near-real-time RAN intelligent controllers (near-RT RICs) of the RAN, the non-RT RIC controlling one or more operations of the near-RT RICs. Further, the system includes multiple E2 nodes that use the RAN via the near-RT RICs. The non-RT RIC is configured to perform a method that includes generating a self-awareness matrix of the RAN, the self-awareness matrix comprises a plurality of records, each record corresponding respectively to each E2 node from the plurality of E2 nodes, a first record corresponding to a first E2 node comprises, for the first E2 node, one or more attributes of a control plane of the RAN, the first E2 node being assigned to a first near-RT RIC. The method further includes, in response to the first record satisfying a predetermined condition based on the one or more attributes of the control plane reconfiguring the control plane of the RAN.

According to one or more embodiments of the present invention, a computer program product includes a memory device with computer-executable instructions therein, the computer-executable instructions when executed by a processing unit perform a method. The method includes generating a self-awareness matrix of a radio access network (RAN) that comprises a plurality of E2 nodes, the self-awareness matrix comprises a plurality of records for each respective E2 node from the plurality of E2 nodes, a first record corresponding to a first E2 node comprises, for the first E2 node, one or more attributes of a control plane of the RAN, the first E2 node being assigned to a first Near-Real-Time RAN Intelligent Controller (near-RT RIC). The method further includes in response to the first record satisfying a predetermined condition based on the one or more attributes of the control plane reconfiguring the control plane of the RAN.

Embodiments of the invention described herein address technical challenges in computing technology, particularly in fields of telecommunications and computing networks. One or more embodiments of the present invention facilitate improvements to radio access networks (RANs), particularly open-RAN (O-RAN) networks. Embodiments of the present invention facilitate automated scaling and distribution of the optimization processes in O-RAN, namely Near-Real-Time RAN Intelligent Controllers (near-RT RICs) that govern such networks. The technical solutions provided by one or more embodiments of the present invention facilitate an improved user/customer experience and minimize the energy consumption of the network. Such improvements are achieved by enabling dynamic redistribution and optimal placement of the near-RT RICs and E2 nodes based on a dynamic monitoring of the conditions in the O-RAN near-real time control loops, such as transaction load and latency. Further, technical improvements described herein are achieved by enabling optimal assignment of E2 nodes to the near-RT RIC instances. Here, “E2” nodes are devices that communicate with the near-RT RIC via an E2 interface. E2 nodes include centralized units (CUs) and distributed units (DUs).

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings.

FIG. 1 depicts an Open Radio Access Network (O-RAN) architecture according to one or more embodiments of the present invention;

FIG. 2 depicts a flowchart of a method to dynamically reconfigure a control plane of a O-RAN according to one or more embodiments of the present invention;

FIGS. 3-7 depict examples of dynamically reconfigured O-RAN according to one or more embodiments of the present invention;

FIG. 8 depicts an example self-awareness matrix of a control plane according to one or more embodiments of the present invention;

FIG. 9 depicts various deployment options according to one or more embodiments of the present invention;

FIG. 10 depicts a sequence of operations performed by the O-RAN components to facilitate the redistribution of the control plane according to one or more embodiments of the present invention; and

FIG. 11 depicts a computing environment in accordance with one or more embodiments of the present invention.

The diagrams depicted herein are illustrative. There can be many variations to the diagrams, or the operations described therein without departing from the spirit of the invention. For instance, the actions can be performed in a differing order, or actions can be added, deleted, or modified. Also, the term “coupled,” and variations thereof describe having a communications path between two elements and do not imply a direct connection between the elements with no intervening elements/connections between them. All of these variations are considered a part of the specification.

In the accompanying figures and following detailed description of the disclosed embodiments, the various elements illustrated in the figures are provided with two or three-digit reference numbers. With minor exceptions, the leftmost digit(s) of each reference number corresponds to the figure in which its element is first illustrated.

### DETAILED DESCRIPTION

Description herein makes reference to Third Generation Partnership Project (3GPP) system, the O-RAN Fronthaul Working Group, and the xRAN Fronthaul Working Group. The description herein uses abbreviations, terms and technology defined in accord 3GPP technology standards, O-RAN Fronthaul Working Group technology standards, and xRAN Fronthaul Working Group technology standards. As such, the 3GPP, O-RAN Fronthaul Working Group, and xRAN Fronthaul Working Group technical specifications (TS) and technical reports (TR) referenced herein are incorporated by reference in their entirety herein and define the related terms and architecture reference models that follow. References may also made to CPRI, the Industry Initiative for a Common Public Radio Interface, and abbreviations, terms and technology defined in eCPRI technology standard may also be used consistent with 3GPP technology standards. The CPRI technical specification eCPRI specifications (e.g., V1.1 (2018 Jan. 10)), is also incorporated by reference in its entirety herein.

Embodiments of the invention described herein address technical challenges in computing technology, particularly in fields of telecommunications and computing networks. One or more embodiments of the present invention facilitate improvements to radio access networks (RANs), particularly open-RAN (O-RAN) networks. Embodiments of the present invention facilitate automated scaling and distribution of the optimization processes in O-RAN, namely Near-Real-Time RAN Intelligent Controllers (near-RT RICs) that govern such networks. The technical solutions provided by one or more embodiments of the present invention facilitate an improved user/customer experience and minimize the energy consumption of the network. Such improvements are achieved by enabling dynamic redistribution and optimal placement of the near-RT RICs based on a dynamic monitoring of the conditions in the O-RAN near-real time control loops, such as transaction load and latency. Further, technical improvements described herein are achieved by enabling optimal assignment of E2 nodes to the near-RT RIC instances. Here, “E2” nodes are devices that communicate with the near-RT RIC via an E2 interface. E2 nodes include centralized units (CUs) and distributed units (DUs).

Conventional RANs were built employing a single unit that processed the entirety of communication protocols for the RAN. The RAN network traditionally used application specific hardware for processing, making them difficult to upgrade and evolve. However, communication networks and needs evolved, with growing need to support increased capacity. Accordingly, there were (and still are) efforts to reduce the costs of RAN deployment and improve scalability and upgradeability of the RAN equipment. Cloud based Radio Access Networks (CRAN) are networks where a significant portion of the RAN layer processing is performed at a centralized/central unit (CU), sometimes also referred to as a baseband unit (BBU). Typically, the CU is located in the cloud on commercial off the shelf servers while the RF and real-time critical functions are processed in a remote radio unit (RU or RRU) and a distributed unit (DU). In some embodiments, the DU can be part of the CU/BBU depending on the functional split.

CRAN provides centralization and virtualization of RAN, with improvements over earlier architecture of RAN. Such improvements include reduction in operating cost (e.g., because of resource pooling, enabling economies of scale etc.), performance improvements (e.g., improved interference), remote upgradeability and management, and improved configurability of features (e.g., transition from 4G to 5G networks).

By using distributed cloud technology, CRAN ensures flexibility and scalability of the network and opens up the possibility to support modern end-user services, such as virtual reality, V2X, remote surgery and many more, that have much stricter service level agreement (SLA) requirements compared to the legacy services. Operation processes in modern networks are automated because they are to occur at a sub-second time scale. The state-of-the-art networks must be able to support different use cases with various SLA requirements at the same time, e.g., high throughput, ultra-low latency, better signal quality, etc. In this respect, the technical challenges posed to modern networks include at least the following: optimize network utilization by scheduling resource allocations and implementing self-optimization rules at a sub-second time scale; and act swiftly on dynamic network conditions, such as traffic bursts or traffic shifts, to ensure the SLA for all the active services.

The automated network operations for self-decision making have become essential and inevitable part of the overall network design. Indeed, the modern network architectures integrate operation processes in their overall design and, as a result, include network infrastructure that is used to control the user traffic. The footprint of such a modern network architecture is increased compared to the legacy networks, which is driven by the increase in the network traffic amount and strict SLA requirements of the novel services. Further, modern network infrastructure has been improved to host the automated operations processes. This infrastructure must be installed in the proximity of the end-users, it must be redundant and fail-safe. Compared to the legacy networks, the amount of infrastructure for operations is significantly increased.

As a result, the overall network infrastructure in the modern networks is significantly increased compared to the legacy networks. O-RAN is one such example of the state-of-the-art modern network. Besides network infrastructure that is used to carry the user traffic in O-RAN (hosting RUs, O-DUs and O-CUs, small cells etc.), telecommunication operators have to introduce additional extensive network infrastructure to host the non-RT RICs and several near-RT RICs for faster decision-making control loops.

Broadly, an O-RAN is a nonproprietary version of a CRAN system that allows interoperation between network equipment provided by different vendors. The O-RAN Alliance issues specifications and standards that the vendors are required to facilitate operation of an O-RAN system.

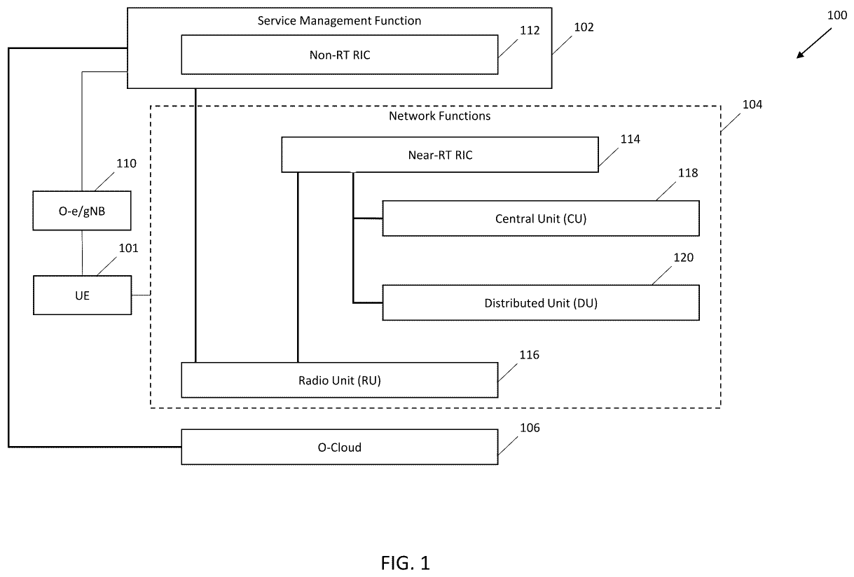

A brief description of an O-RAN architecture is now described with reference to FIG. 1. It is understood that other embodiments of the present invention can use different, fewer, or additional components than depicted herein without diverging from the technical solutions described herein. In some embodiments of the present invention one or more components depicted herein may be combined or further split (distributed), again without diverting from the technical solutions described herein.

The O-RAN architecture 100 includes several components that inter-communicate over different interfaces. Each interface uses a different name per the O-RAN specification, and includes the A1 interface, the O1 interface, the O2 interface, and the Open Fronthaul Management (M)-plane interface. The interfaces connect the Service Management and Orchestration (SMO) framework 102 to O-RAN network functions (NFs) 104. The NFs 104 include for example, near-RT RICs 114, radio units 116, and other components. The interfaces also connect the SMO 102 and the O-Cloud 106. The O-Cloud 106 can be a cloud computing platform including a collection of physical infrastructure nodes to host the relevant O-RAN network functions (e.g., the near-RT RIC 114, O-CU 118, O-DU 120), supporting software components (e.g., operating systems, virtual machines, container runtime engines, machine learning engines, etc.), and appropriate management and orchestration functions. It should be noted that the SMO 102 and the other components shown can connect with other components (e.g., an enrichment data source, NG-CORE, etc.) that are not depicted herein.

The SMO 102 includes the non-RT RIC 112, which connects with the near-RT RIC 114, for example, via the A1 interface. The SMO 102 can also connect with one or more of the NFs 104. The O-RAN NFs 104 can be virtual network functions (VNFs) such as virtual machines or containers, implemented above the O-Cloud 106 layer and/or above one or more Physical Network Functions (PNFs). The O-RAN NFs 104 may be implemented using customized hardware, however, all the O-RAN NFs 104 support the O1 interface when interfacing with the SMO framework 102.

Further, the SMO 102 manages the O-RAN Radio Unit (O-RU) 116 via the Open Fronthaul M-plane interface. The Open Fronthaul M-plane interface is an optional interface that is included for backward compatibility purposes in particular modes, such as the hybrid mode as defined in O-RAN specifications.

Conventionally, the SMO 102 with the non-RT RIC 112, and the O-Cloud 106 are referred to as “management portion/side” of the O-RAN 100; and the near-RT RIC 114, the O-DU 120, the O-RU 116, the O-CU 118 functions are referred to as “radio portion/side” of the O-RAN architecture 100. In some embodiments of the invention, the radio portion/side also include the gNB 110. The gNB 110 is an LTE eNB, a 5G gNB or ng-eNB that supports the E2 interface.

The O-RU 116 is a logical node hosting lower PHY layer entities/elements (Low-PHY layer) (e.g., FFT/iFFT, PRACH extraction, etc.) and RF processing elements based on a lower layer functional split. Virtualization of O-RU 116 is FFS. The O-CU 118 is a logical node hosting the RRC and the control plane (CP) part of the PDCP protocol. The O-CU 118 also hosts the user plane part of the PDCP protocol and the SDAP protocol. The O-DU 120 is a logical node hosting RLC, MAC, and higher PHY layer entities/elements (High-PHY layers) based on a lower layer functional split. Conventionally, the O-CU 118 and the O-DU 120 are referred to as “E2” nodes, because the near-RT RIC 114 connects with them via the E2 interface. In some cases, the gNB 110 may also be included as an E2 node for the same reasons. The protocols over E2 interface are based exclusively on Control Plane (CP) protocols. The E2 functions are grouped into the following categories: near-RT RIC services (REPORT, INSERT, CONTROL and POLICY); near-RT RIC support functions, which include E2 Interface Management (E2 Setup, E2 Reset, Reporting of General Error Situations, etc.); and near-RT RIC Service Update (e.g., capability exchange related to the list of E2 Node functions exposed over E2).

In one or more embodiments of the present invention, the Uu interface is used between a UE 101, the gNB 110, and any other O-RAN components. The Uu interface is a 3GPP defined interface, which includes a complete protocol stack from L1 to L3. While only single components are shown herein, it is understood that the O-RAN 100 can include several UEs 101 and/or several gNB 110, each of which may be connected to one another the via respective Uu interfaces. Also, while not shown, the O-RAN architecture 100 can include other interfaces (E1, F1-c, NG-c, X2-c, etc.) that connect the components to other components (that are not shown, e.g., en-gNB, gNB-CU, etc.) and/or to components that are shown.

The non-RT RIC 112 is a logical function within the SMO framework 102 that enables non-real-time (>1 second operation times) control and optimization of RAN elements and resources; AI/machine learning (ML) workflow(s) including model training, inferences, and updates; and policy-based guidance of applications/features in the near-RT RIC 114. In some embodiments of the present invention, the non-RT RIC 112 can be an ML training host to host the training of one or more ML models. ML training can be performed offline using data collected from the near-RT RIC, O-DU 120, and O-RU 116. The near-RT RIC 114 is a logical function that enables near-real-time (sub 1 second operation times) control and optimization of RAN elements and resources via fine-grained, data collection and actions over the E2 interface. The near-RT RIC 114 may include one or more AI/ML workflows including model training, inferences, and updates.

O-RAN is built on the foundation of virtualization, automation, and cloud technologies. NFs 104 are disaggregated and there are open interfaces between them. To be able to support the modern services, O-RAN integrates automated operations into its overall architecture by providing three control loops of different time scales for different operation and optimization processes. The non-real-time control loop (involving the non-RT RIC 112 in SMO 102) has above-second time-frame, the near-real time control loop (involving the near-RT RICs 114) has sub-second time-frame, and finally, the real-time control loop (involving the O-DU 120) has the time-frame that is below 10 ms.

The cloud-native nature of the NFs 104 in the O-RAN allow various deployment options, in which some or all functionalities can be bundled together as per the infrastructure availability and operator deployment preference. For more details regarding deployment options, one should refer to the Technical Specification document “O-RAN Architecture Description” from O-RAN WG1. Any O-RAN deployment scenario must ensure that the timing requirements of each of the three control loops are met.

O-RAN specifications further characterizes the interfaces into a control plane, a management plane, a synchronization plane, and a user plane. Control Plane (C-plane) refers to real-time control between O-DU 120 and O-RU 106, not including the IQ sample data (part of the User Plane). Management Plane (M-plane) refers to non-real-time management operations between the O-DU 120 and the O-RU 106. Synchronization Plane (S-Plane) refers to traffic between the O-RU 106 or O-DU 120 to a synchronization controller which is generally an IEEE-1588 Grand Master. Grandmaster not only represents a highly accurate source of synchronization for all network devices supporting the Precision Time Protocol (PTP), the Network Time Protocol (NTP), and the Simple Network Time Protocol (SNTP), etc., it also offers a number of legacy time and frequency outputs for keeping non-networked devices in-sync. User Plane refers to IQ sample data transferred between O-DU 120 and O-RU 106.

The C- and U-plane Ethernet stack commonly uses a UDP (User Datagram Protocol) to carry eCPRI or RoE (Radio over Ethernet). If RoE is selected, it is carried over Ethernet L2 with a VLAN; eCPRI can be carried over Ethernet L2, or UDP. The C- and U-plane both have the highest priority via the VLAN (priority 7) and within the IP layer are defined as Expedited Forwarding.

The S-plane Ethernet stack uses Ethernet to carry PTP (Precision Time Protocol) and/or SyncE (Synchronous Ethernet) traffic so that end mobile elements are time-synchronized. In 5G networks, for example, it is particularly important that each RU, especially RUs in the same segment or adjoining segments (locations where UE (User Equipment) may be in contact with multiple RUs), is time-synchronized, allowing the 5G network to maintain high throughput while downloading data from multiple RUs at once, or while transferring from one RU to another.

The M-plane Ethernet stack uses TCP (Transmission Control Protocol) to carry the management messages between the RU 106 and DU 120. O-RAN defines a NETCONF/YANG profile to be carried over this layer via SSH (Secure Shell), allowing communication between the RU 106 and DU 120.

While the user plane in O-RAN benefits from dynamic reconfiguration and deployment in the cloud-native deployment that allows meeting user demand, the control plane is static. The near-RT RICs 114 that are in the control plane are statically deployed. Presently, in O-RAN dynamicity is not considered in the context of the control plane. Technical solutions facilitated by one or more embodiments of the present invention facilitate the control and optimization plane in O-RAN to enforce awareness of the current and predictive traffic demand in both, control, and user plane as well as the available hardware, and accordingly dynamically adaptation can be done. Accordingly, embodiments of the present invention facilitate redistribution of the near-RT RICs 114 and reassignment of E2 nodes (CUs 118, and DUs 120) as an automated dynamic adjustment of the O-RAN control plane based on one or more changing conditions in the user plane. For example, the control plane is adjusted due to non-deterministic traffic and burst traffic.

A technical challenge with the O-RAN network infrastructure includes the energy footprint. Embodiments of the present invention address the energy consumption by minimizing energy consumption of network infrastructure. In turn, embodiments of the present invention improve economic benefits, ethical responsibility, and environmental impact of network operators. In current state of art there are no network governed (self-guided/automated) policies to dynamically distribute/scale the network infrastructure workloads for efficient automated operations which can dynamically and intelligently tradeoff between energy consumption needs and operation efficiency for next generation application quality of service (QoS).

As described in detail herein, one or more embodiments of the present invention facilitate dynamic redistribution of the near-RT RICs 114 based on one or more of the following decisions: (1) centralization (with instance merging) (2) redistribution or (3) migration of the existing near-RT RIC 114 instances to more suitable physical locations targeting at the same time minimal energy consumption and optimization of the customer experience. In one or more embodiments of the present invention, an algorithm is run in the (centralized) AI/ML-capable non-RT RIC 102. Accordingly, embodiments of the present invention facilitate distribution/scaling of the operations processes in O-RAN, namely processes that are supported with the near-RT RICs, that aims to optimize energy consumption and at the same time enhance operations efficiency to achieve the next gen customer experience.

The non-RT RIC 102 analyzes an overall amount of control signaling in the control plane, for example, latency requirements (autonomous action response time) imposed on the optimization processes hosted in the near-RT RICs 114 and the overall transaction load on each individual near-RT RIC 114. Non-RT RIC 102 correlates such collected information with the information about the user traffic demand, current energy consumption of the near-RT RICs 114, and the available hardware in the observed domain and its conditions. In some embodiments of the present invention, the latter is used to identify the potential hosts for newly redistributed near-RT RICs 114. Accordingly, the non-RT RIC 102 establishes full awareness of the control plane, energy consumption, and the requirements imposed by the user plane traffic. Non-RT RIC 102, based on such information, makes the decision on how to dynamically redistribute and optimally place the Near RT RICs 114 to achieve the best customer experience with optimum (e.g., minimum) power consumption.

Embodiments of the present invention further facilitate a soft handover for redistribution of the E2 nodes to newly created near-RT RICs 114.

Accordingly, embodiments of the present invention improve O-RAN architectures, such as the O-RAN architecture 100. Embodiments of the present invention, accordingly, is rooted in computing technology, and facilitates improvement to computing technology, particularly communication networks using O-RAN architecture. Such improvements include dynamic reconfiguration of the control plane in the O-RAN architecture based on one or more performance parameters monitored in the O-RAN. Additional improvements provided by embodiments of the present invention include optimizing the resource consumption, e.g., power consumption of the O-RAN, particularly near-RT RICs 114. Further, embodiments of the present invention provide a practical application in the field of computing technology, particularly O-RAN, by reconfiguring the control plane, which includes redistributing/migrating/centralization of devices in the control plane, such as near-RT RICs 114, CUs, 118, and DUs 120.

In general, centralized deployments, where the NFs 104 follow the hierarchy in which one controls many (e.g., one near-RT RIC 114 controlling many O-CUs 118 and O-DUs 120), are desired as they maximize centralization gains and minimize the energy consumption. However, the centralized deployments are not always optimal as it may lead to lag in autonomous optimization processes that must assure fulfillment of demanding service level agreement (SLA) requirements of various end-user services (e.g., autonomous vehicle, smart industry). Quickly changing radio conditions, non-deterministic traffic and burst traffic require prompt responses from optimization processes and often do not tolerate propagation delays to centrally deployed near-RT RICs 114.

In the state-of-the-art telecommunication networks, there are no governed policies to dynamically distribute/scale the network infrastructure workloads for efficient automated optimization processes, which can follow the user plane requirements and smartly tradeoff between huge energy consumption needs and enhanced optimization efficiency for next generation application quality of service (QoS). In the present state-of-the-art, the E2 nodes (CUs, and DUs) are statically assigned to static near-RT RICs 114. Embodiments of the present invention facilitates dynamic redistribution of near-RT RICs 114 and/or dynamic reassignment of E2 nodes (CUs, and DUs).

Accordingly, embodiments of the present invention facilitate establishing control plane self-awareness by continuously monitoring the state in the control plane. Further, a self-awareness matrix that represents the extensive state information is created. The self-awareness matrix collects the information about each deployed near-RT RIC 114, the O-CUs/O-DUs (118, 120) that are under the control of each near-RT RIC 114. The collected information can include the amount of control plane traffic that reaches each near-RT RIC 114 and to which each near-RT RIC 114 must react, the profile of the users that are covered by the O-CUs/O-DUs (118, 120), e.g., their QoS agreements, mobility profiles, amount of traffic, etc. In one or more embodiments of the present invention, the self-awareness matrix also includes data about hardware assets that are available for the deployment of new instances of the near-RT RIC 114 or for the migration of near-RT RICs 114 that are already deployed. The self-awareness matrix further includes data about the energy that is consumed for the control plane.

Further, as described herein, one or more embodiments of the present invention facilitate near-RT RIC 114 distribution for optimal energy consumption and enhanced optimization efficiency for improved customer experience. The reconfiguration of the near-RT RICs 114 is based on analysis of the self-awareness matrix. In one or more embodiments of the present invention, the reconfiguration is performed when (1) conditions have been met to reduce energy consumption of the control plane; and/or (2) conditions have been met in which quality of experience is to be increased by scaling-out the control and optimization processes.

Embodiments of the present invention further facilitate soft handover of E2 nodes on the newly distributed/created instances of the near-RT RIC 114. Embodiments of the present invention provide a set of messages that are to be exchanged between the non-RT RIC 102, source near-RT RIC 114, target near-RT RIC 114, and E2 nodes (CUs, DUs).

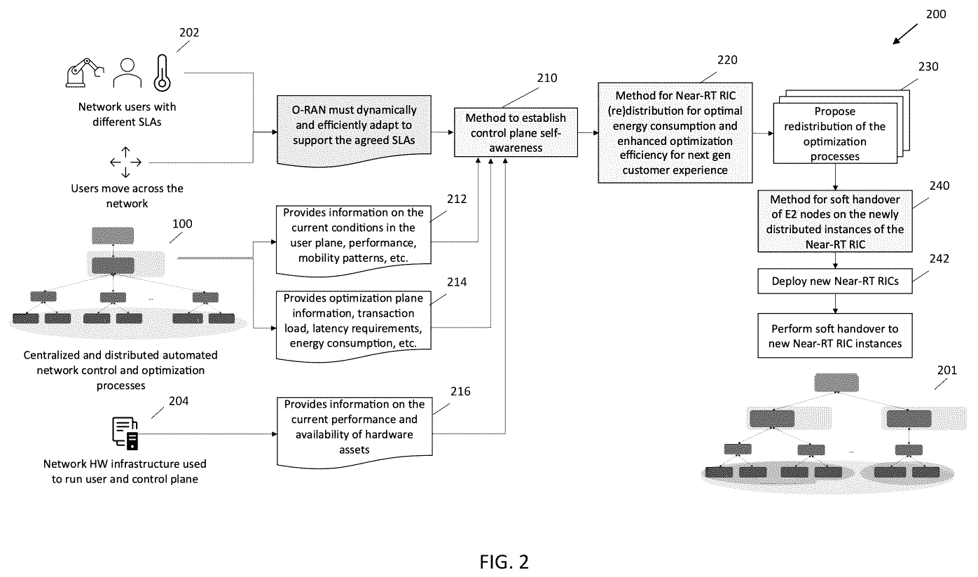

FIG. 2 depicts a flowchart of a method to dynamically reconfigure a control plane of a O-RAN according to one or more embodiments of the present invention. The flowchart depicts an O-RAN 100 to which several users 202 connect. The users 202 can be represent one or more user equipment, which can be of any type. For example, the users 202 include IoT enabling devices (e.g., sensors, etc.), automated devices (e.g., factory appliances, home appliances, automated vehicles, etc.), user devices (e.g., phones, tablets, laptops, servers, etc.), or any other types of electronic devices that use the O-RAN 100 for communication. The O-RAN 100 uses one or more hardware equipment 204, which can include computer servers, modems, routers, switches, computing devices, and any other hardware devices used to implement a networking infrastructure. The hardware devices may implement one or more components of the O-RAN 100 (see FIG. 1) as virtual machines, software developed network modules, machine learning modules, or any other combination thereof.

The method 200 facilitates dynamically reconfiguring the control plane of the O-RAN 100, depicted by a second O-RAN combination 201. In some embodiments of the present invention, the second O-RAN 201 includes the same exact hardware equipment 204 that implemented the O-RAN 100, which is now reconfigured to implement the adjusted control plane. The O-RAN 201, for example, includes a different number of near-RT RICs 114 compared to O-RAN 100. Alternatively, or in addition, the O-CUs 118 and O-DUs 120 in the O-RAN 100 are reconfigured in relation to the near-RT RICS 114.

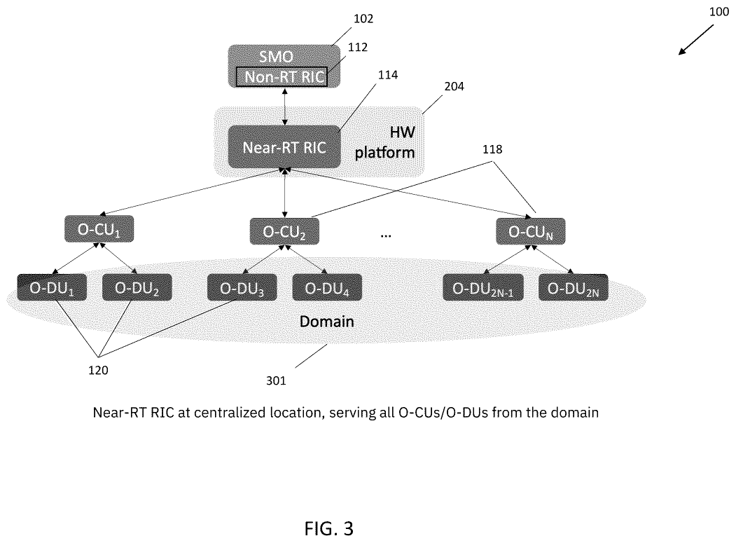

FIGS. 3-7 depict examples of dynamically reconfigured O-RAN according to one or more embodiments of the present invention. FIG. 3 depict the O-RAN 100 in an abridged manner. A single near-RT RIC 114 is depicted to be implemented on the hardware equipment 204, and in communication with N O-CUs 118. The O-CUs 118 are, in turn, in communication with M O-DUs 120 arranged as part of a domain 301. A “domain” is group of base stations/Network nodes handled by certain near-RT RIC 114. It is understood that the number of DUs shown to be in a domain is just an example, and that there can be different number of DUs under a CU or single DU under a CU, or any other combination is possible in other examples. In the first O-RAN 100 (before reconfiguring the control plane), the near-RT RIC 114 at centralized location, serves all O-CUs/O-DUs (118, 120) from the domain 301.

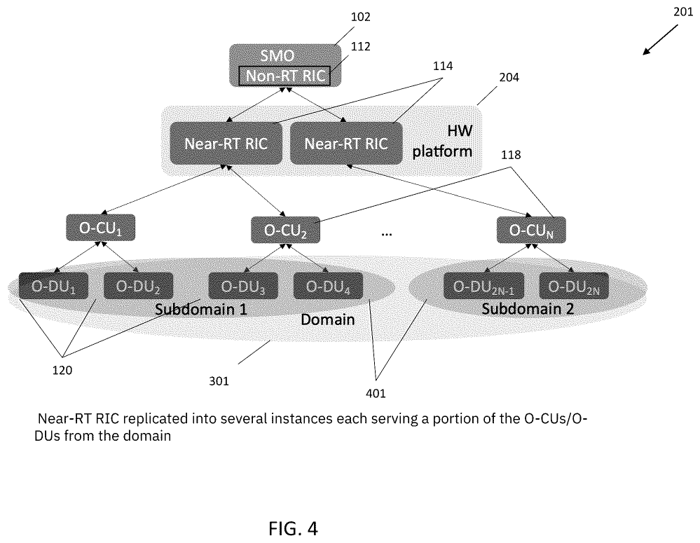

FIG. 4 depicts an example O-RAN 201, which is the O-RAN 100 with the control plane reconfigured in an example manner by the method 200. By this reconfiguration, the single near-RT RIC 114 (from FIG. 3) is replicated/split into several instances of near-RT RICs 114, two are shown in FIG. 4. Further, each near-RT RIC 114 serves only a portion or subset of the O-CUs/O-DUs (118, 120) from the domain 301. In one or more embodiments of the present invention, the domain 301 is also split into one or more subdomains 401.

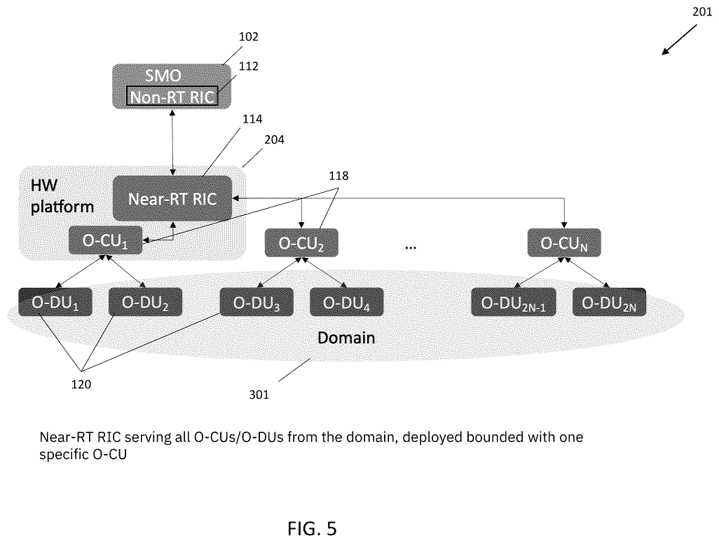

FIG. 5 depicts another example O-RAN 201, which is the O-RAN 100 with the control plane reconfigured in an example manner by the method 200. By this reconfiguration, the near-RT RIC 114 still serves all O-CUs/O-DUs (118, 120) from the domain 301, but the near-RT RIC 114 is now deployed bounded with one specific O-CU 118.

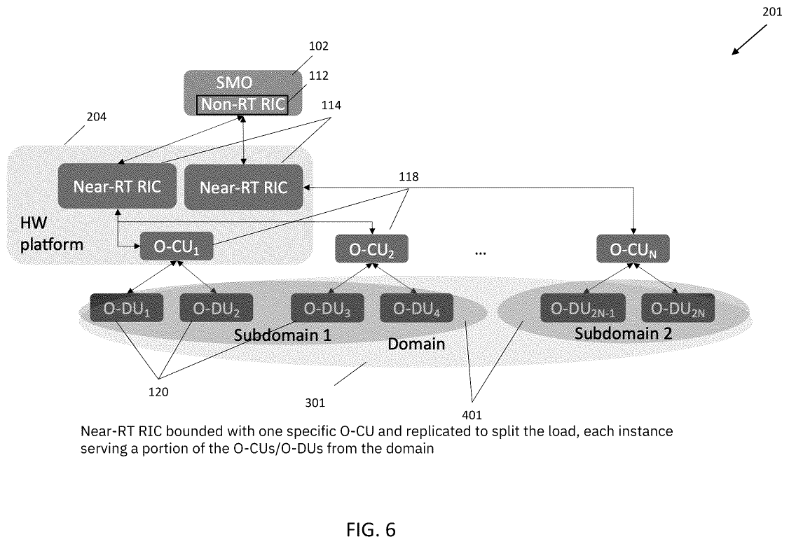

FIG. 6 depicts another example O-RAN 201, which is the O-RAN 100 with the control plane reconfigured in an example manner by the method 200. By this reconfiguration, the near-RT RIC 114 is bounded with one specific O-CU 118 and replicated to split the load. Further, each instance of the near-RT RIC 114 serves a portion/subset of the O-CUs/O-DUs (118, 120) from the domain 301.

Examples provided herein depict reconfigurations the control plane in which additional near-RT RICs 114 are included in the second O-RAN 201; or two or more near-RT RICs 114 from the O-RAN 100 are merged to create a near-RT RIC 114 in the O-RAN 201. Alternatively, or in addition, the near-RT RICs 114 of the O-RAN 201 are distributed differently compared to the O-RAN 100. It should be noted that the reconfiguration can be performed in other manners than the examples herein.

Referring to the flowchart of method 200, at block 210, the non-RT RIC 104 generates a self-awareness matrix (800) of O-RAN.

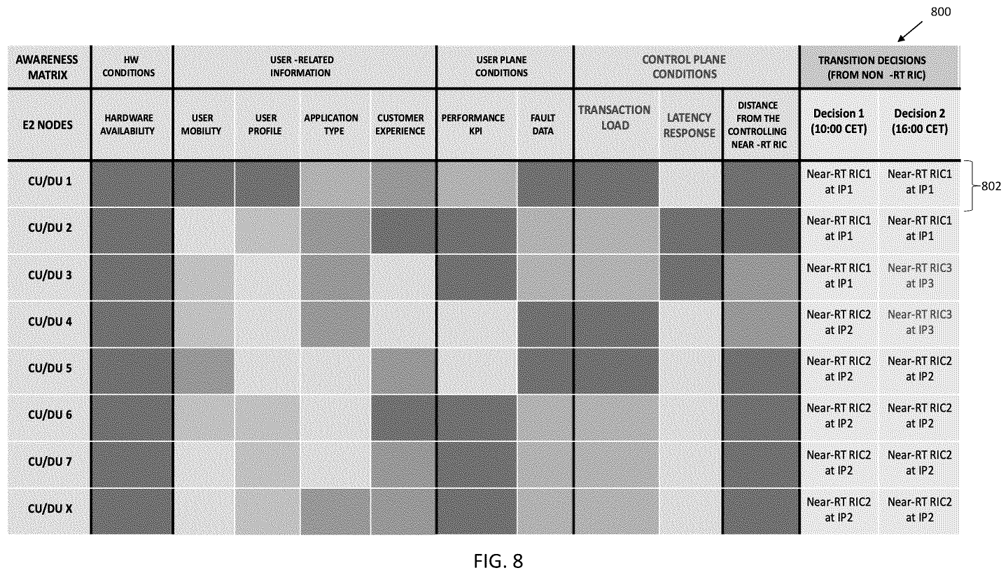

FIG. 8 depicts an example self-awareness matrix 800 of a control plane according to one or more embodiments of the present invention. The self-awareness matrix 800 is a specific data structure that stores and organizes parameters of the O-RAN 100 in a particular and specialized manner. The self-awareness matrix 800 includes multiple records 802, each record 802 corresponding to each respective E2 node (O-CU 118/O-DU 120) from the O-RAN.

The record 802 may represent that the E2 node is assigned to the near-RT RIC 114. Each record 802 includes, for the corresponding E2 node, one or more attributes of the control plane of the O-RAN 100. In one or more embodiments of the present invention, the control plane attributes capture (or includes), at 214, for the E2 node, a transaction load, a latency response, an amount of energy consumption, and a distance of that E2 node from the near-RT RIC 114. Other and/or additional attributes can be stored in other embodiments of the present invention.

Each record 802 further captures (or includes), at 212, for the corresponding E2 node, one or more attributes of the user plane of the O-RAN 100. The user plane attributes include a performance key performance indicator (KPI), and fault data. Other and/or additional attributes can be stored in other embodiments of the present invention.

Each record 802 further captures (or includes), at 212, for the corresponding E2 node, one or more user-related information attributes. The user-related information attributes can include a user mobility, a user profile, an application type, and a customer experience. Other and/or additional attributes can be stored in other embodiments of the present invention.

Each record 802 further captures (or includes), at 216, for the corresponding E2 node, one or more attributes of the hardware equipment 204. For example, the hardware equipment attributes can include a hardware availability.

It should be noted that in FIG. 8, the several types of attributes captured in the self-awareness matrix 800 are captured by the non-RT RIC 104 continuously (e.g., once every millisecond, every fifth millisecond, or any other frequency). The captured attributes for the E2 nodes in the O-RAN 100 can be stored in columns in a table as shown in FIG. 8, where each row is the record 802 representing each E2 node.

At block 220 in the flowchart, the non-RT RIC 112 analyzes the self-awareness matrix 800. Based on the analysis, the non-RT RIC 112 proposes a redistribution of the optimization processes. There are various implementations of this algorithm. For example, the algorithm can enforce stochastic learning and track historical decisions identifying the best ones for specific control and user plane conditions and hardware availability. Algorithm can lead to different setups in the control plane, e.g., combinations shown in the FIGS. 3-7.

In general, centralized deployments, in which the NFs 104 are not bundled together but follow the hierarchy in which one controls many (e.g., one near-RT RIC 114 controlling multiple O-CUs 118 and O-DUs 120), are desired as they maximize centralization gains and minimize the energy consumption. Indeed, instantiation of a lower number of near-RT RICs 114 implies lower underlying hardware usage and thus reduced energy consumption. However, the centralized deployments are not always optimal as interventions of the centrally deployed network operational algorithms might not target the distributed network geography, as necessary. Instead, the traffic pattern at network end A may be such that it requires a lot of quick intervention from network operations algorithms, e.g., by the xApps deployed on the near-RT RIC 114, and these interventions must be performed with the minimum round trip. At the same time, the traffic pattern on network end B may be such that it requires minimal interventions from the xApps deployed on the near-RT RIC 114. In this specific case the near-RT RIC 114 must be deployed closer to the network end A, e.g., potentially bundled to certain O-CU/O-DU (118/, 120) in the network end A, to guarantee faster enforcement of the optimization activities from the operational algorithms, i.e., xApps. The selection of the number of near-RT RIC 114 instances to run in one geography to support the SLA of the active services and the selection of the locations on which these near-RT RIC 114 instances would be deployed must be carefully done. Otherwise, too many near-RT RICs 114, which are placed close to the O-CU/O-DU (118, 120) that cover demanding network ends, can lead to enormous energy consumption and high increases in the total operator's operating expense. As noted throughout herein, embodiments of the present invention address such technical challenges by analyzing the self-awareness matrix and redistributing the control plane based on the analysis.

In O-RAN each network function 104 is deployed as a container. Here, “containers” are executable units of software in which application code is packaged, along with its libraries and dependencies, in common ways so that it can be run anywhere, whether it be on desktop, traditional IT, or the cloud. It should be noted that containers unlike virtual machines, do not need include a guest OS in every instance and can, instead, simply leverage the features and resources of the host OS.

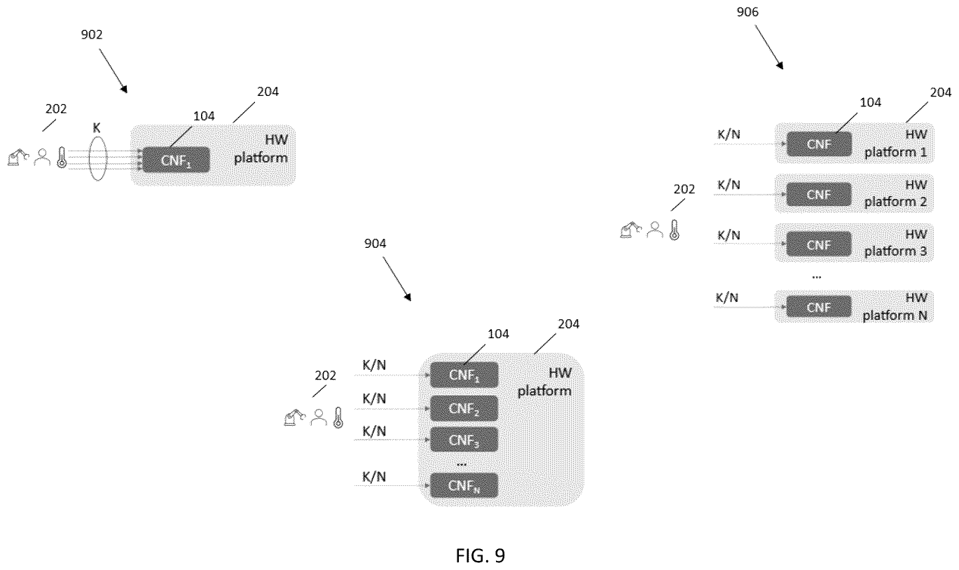

FIG. 9 depicts various deployment options according to one or more embodiments of the present invention. An analysis of energy consumption of cloud-native applications with respect to several deployment options is discussed further. In deployment 902 one application instance serves K number of users. In deployment 904 a fully centralized deployment with N number of instances of the cloud-native applications is deployed on the same hardware platform 204 (the application is scaled-out on the same hardware platform). Each instance serves a portion of the users, which is K/N. The deployment 906 is a fully distributed deployment with N number of instances of the cloud-native application, each deployed on a separate hardware platform 204 (the application is scaled-out across multiple hardware platforms). Each instance serves a portion of the users, which is K/N.

The energy consumption of the application instance from deployment 902 does not differ significantly from the energy consumption of all the deployed instances in the fully centralized deployment from the deployment 904, if each serves only a portion of the N number of users (which is K/N). The power consumption in the deployment 904 is not N times the power consumption measured in the deployment 902. On the other hand, when the N number of application instances run as fully distributed (deployment 906), the energy consumption of the overall system equals N times of the power consumption of each instance separately (this is the energy consumption of one instance serving K/N users).

Consider an example scenario of a system in which 64 users are to be served with the total of 4 container instances, the following three possibilities for the network functionality instance deployment can be compared: First, all 4 instances are deployed as fully centralized (FC) in the same server. Second, 4 instances are deployed as fully distributed (FD). This implies that each instance runs on a separate server. And third, a mixed deployment is used, in which some instances are running on their exclusively dedicated hardware platforms, and some are sharing the hardware platform with other instances. Table 1 shows example energy consumption in the different deployment scenarios.

TABLE 1

| Deployment Model | Calculation | | Energy Consumption |
|---|---|---|---|
| FC | 1.2 | W | 1.2 W |
| FD | 4 * 0.5 | W | 2.0 W |
| Mixed (e.g., 2 instances | 0.8 W + 2 * 0.5 W | | 1.8 W |
| collocated in same server, | | | |
| and 2 instances running on | | | |
| separate server) | | | |

It can be seen from Table 1 that different deployment options have different energy consumption. It is understood that the values in Table 1 illustrate one possible example, and that the energy consumption can vary in other examples. Embodiments of the present invention define intelligent algorithms aimed at identifying the optimal placement of network functions 104 in O-RAN 100 that optimizes power consumption. Embodiments of the present invention facilitate each traffic and use case pattern to have its optimal placement of network functionalities 104, with a near-RT RIC 114 handling as many O-CUs/O-DUs (118, 120) whenever possible.

To this end, embodiments of the present invention facilitate dynamic placement of the O-RAN components near-RT RIC 114 aiming to increase the centralization gain and reduce energy consumption.

Referring to method 200, non-RT RIC 112 captures the information about network-wide conditions. For example, information about the underlying cloud infrastructure is received over the interface O2. FCAPS-related information about the deployed network functions can be captured over the interface O1. Further, information about the user plane conditions is received from all the connected near-RT RICs 114 over the A1 interface. Each near-RT RIC 114 has the information about local domain conditions, e.g., about the user and control plane conditions received from the connected E2 nodes and information about the local hardware on which it is deployed, e.g., CPU usage, available cores, etc.

In one or more embodiments of the present invention, the analysis and redistribution of the control plane is facilitated by the non-RT RIC 112 using an AI/ML training model. As part of the redistribution (reconfiguration, adjustment, redeployment, etc.) non-RT RIC 112 deploys policies to the near-RT RIC 114. The policies mandate the near-RT RICs 114 to autonomously react when certain local conditions are met by scaling within the local hardware platform. Alternatively, or in addition, the policies mandate the near-RT RICs 114 to inform the non-RT RIC 112 when certain local conditions are met for which decision based on the local conditions is not possible. In such case the decision is made by the non-RT RIC 112 using insight into the network-wide conditions.

In one or more embodiments of the present invention, the redistribution is performed based on user plane conditions captured in the self-awareness matrix 800, i.e., traffic pattern, including the information regarding the applications that the users 202 use at specific time and the amount, traffic burst handling and SLA requirement of traffic that they produce. It should also include the Business Support System (BSS) data to aggregate the user profiles in geographical area. BSS data includes customer profiling related data.

Alternatively, or in addition, the redistribution of the control plane can be performed based on control plane conditions captured in the self-awareness matrix 800. For example, reporting delay between the O-CUs/O-DUs (118, 120) and the near-RT RIC 114, data processing time, amount of control signaling and the overall transaction capacity that must be supported (these are proportional to the number of interventions needed from the network operations algorithms) and the time that is needed for the updates to be enforced in the network.

Alternatively, or in addition, the redistribution of the control plane can be performed based on Infrastructure conditions captured in the self-awareness matrix 800. For example, state of the available hardware platforms 204, CPU usage, available cores, available memory, etc. are used.

The objective of the redistribution is to increase the centralization gain and reduce the energy consumption in the domain.

At block 230, in response to one or more records 802 in the self-awareness matrix satisfying a predetermined condition based on the one or more attributes, the control plane is reconfigured in this manner. In one or more embodiments of the present invention, the near-RT RIC 114 monitors the domain conditions and user activity, autonomously and makes decision regarding the necessary actions, and triggers their execution.

The redistribution can include several positioning scenarios for the near-RT RIC 114 within the assigned domain. For example, the near-RT RIC 114 is not bundled with any O-CU/O-DU 118, 120 from the domain (FIG. 4). Near-RT RIC 114 is centrally deployed and controls the O-CUs/O-DUs 118, 120 deployed at remote sites. This is optimal for the case when the amount of delay-sensitive user traffic and traffic burst is minimal in the observed domain. In this scenario xApps deployed in near-RT RIC 114 are sufficient to cater the CU/DU traffic. In case higher capacity is required, multiple containers of near-RT RIC 114 are replicated at the remote location. As the multiple containers for same application are instantiated on a single hardware platform 204, a multifold energy consumption increase is not caused when compared to containers for application instantiated at different hardware platforms.

In other examples, near-RT RIC 114 is bundled with one of the controlled O-CU/O-DU 118, 120 (FIG. 5). The near-RT RIC 114 controls the remaining O-CUs/O-DUs 118, 120 deployed at remote sites of the domain with minimal intervention of network operations algorithms. Such a redistribution is optimal for the case when the delay-sensitive user traffic or traffic bursts are unevenly distributed in the observed domain, e.g., mostly originating from one O-CU/O-DU 118, 120 with which the near-RT RIC 114 is collocated.

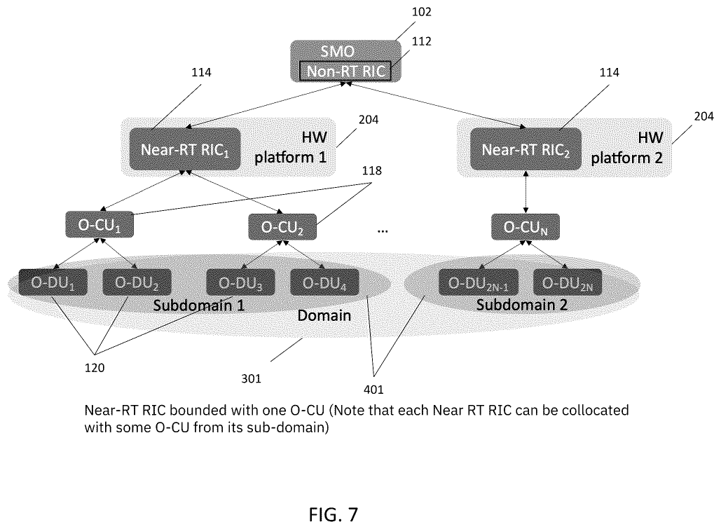

Alternatively, the near-RT RIC 114 instance is replicated into a set of near-RT RIC instances (FIGS. 6, 7). The domain is divided into several subdomains, each controlled by a new dedicated instance of the near-RT RIC 114. Such a redistribution is optimal in the case when there is significant increase in the amount of user and control traffic that is uniformly distributed in the domain, which brings the near-RT RIC 114 instance to its processing limits and might cause congestions and impair the user SLAs.

In yet other embodiments of the present invention, a set of near-RT RIC 114 instances within a main domain can be redistributed in ways other than those given in the previous examples. For example, the near-RT RIC 114 can be redistributed such that new instances are deployed on different hardware platforms. Also, multiple near-RT RIC 114 instances can be merged into only one instance in the domain, effectively collapsing back to the deployment scenario (FIG. 3, 5). The latter occurs when the amount of user and control traffic in the network domain decreases (e.g., during the night hours).

In each of the examples herein (FIGS. 3-7), the delay between the near-RT RIC 114 and each controlled O-CU 118 is such that it allows fulfillment of the timing requirements, i.e., the requirements of the near-real-time control loop.

Referring to the method 200, at block 240, a soft handover of E2 nodes to one or more near-RT RICs 114 is performed. In some examples, the soft handover can include deploying new near-RT RICs 114, at block 242, and then performing soft handover to the newly deployed near-RT RICs 114, at block 244, as described herein.

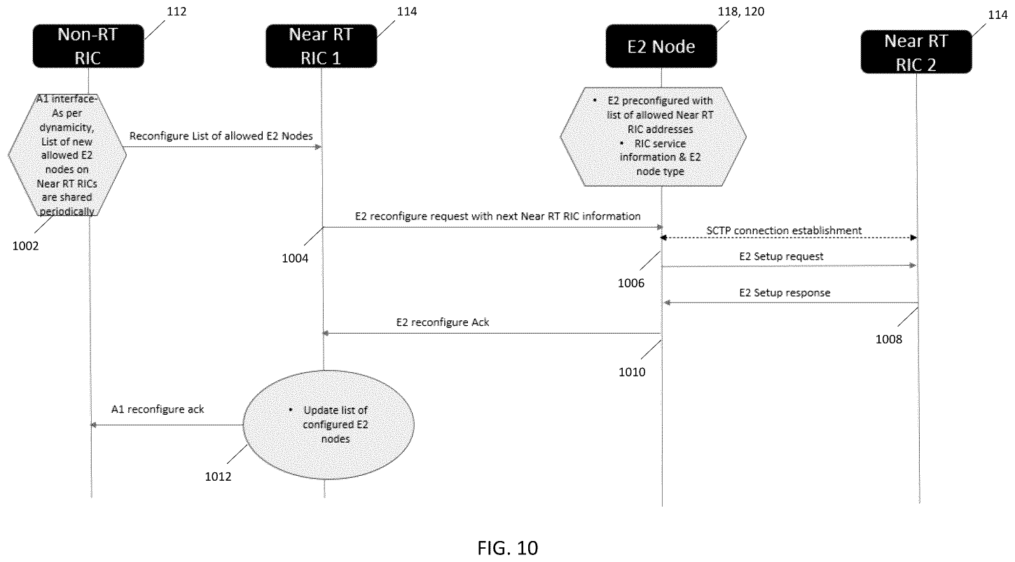

FIG. 10 depicts a sequence of operations performed by the O-RAN components to facilitate the redistribution of the control plane according to one or more embodiments of the present invention. Non-RT RIC 112 continuously monitors the network-wide conditions and can identify the conditions where energy consumption or user experience optimization is to be performed. Non-RT RIC 112 can also receive notification from the near-RT RIC 114 that indicates that local conditions have been met, which require optimization of energy consumption or user experience, for which the near-RT RIC 114 cannot make autonomous decision (e.g., resources on the near-RT RIC 114 underlying hardware platform 204 are exhausted, excluding the possibility for scaling locally). Non-RT RIC 112 identifies responsive actions, which can include scaling-out on other hardware platforms 204 or merging the existing near-RT RIC 114 instances. The non-RT RIC 112 sends the list of the E2 nodes and their respective near-RT RIC 114 instances over A1 interface to all near-RT RIC 114 that are involved in the reconfiguration process (1002). The near-RT RICs 114 leverage the lists for the E2 node (re)configuration.

At 1004, the near-RT RIC 114 parses this information and checks for the E2 nodes that are currently subscribed to it, but which are to be migrated to a new near-RT RIC 114 instance. It sends reconfiguration request to such E2 nodes together with information about the new target near-RT RIC 114.

At 1006, upon receiving the reconfiguration request, the E2 node establishes a connection towards the target near-RT RIC 114 (e.g., SCTP connection) and sends the E2 setup request to the target near-RT RIC 114. The target near-RT RIC 114 also receives the list of the associated E2 nodes (initiated from non-RT RIC 112). At 1008, the target near-RT RIC 114 verifies that the requesting E2 is on the list and sends the E2 setup response.

Upon receiving the acknowledgement from the target near-RT RIC 114, at 1010, the E2 node acknowledges to the source near-RT RIC 114 that configuration process completion is acknowledged, and the old connection and context (between the source near-RT RIC 114 and the E2 node) is not needed any more. Further, at 1012, the source near-RT RIC 114 updates the non-RT RIC 112 regarding the current state and updates its own list of E2 nodes to remove the entry for the E2 node.

Embodiments of the present invention provide several improvements to computing technology. Additionally, embodiments of the present invention provide several practical applications to facilitate operation of O-RAN 100. For example, by leveraging the policies received from the non-RT RIC, the near-RT RIC can autonomously decide on its own scaling based on the local domain conditions. Such scaling-out can occur within the same hardware platform. Further, embodiments of the present invention facilitate near-RT RIC to continuously monitor the local domain conditions and detect the conditions given in the policy received from the non-RT RIC. Also, non-RT RIC identifies actions, such as scaling-out or merging existing instances of near-RT RICS. Alternatively, the near-RT RIC can also inform the non-RT RIC that self-decision cannot be made and request the action from the non-RT RIC. For example, E2 reconfiguration procedure may require non-RT RIC intervention. In one or more embodiments of the present invention, the near-RT RIC creates the list with the distribution of the currently subscribed E2 nodes to the new instances, obtained after scaling action has been taken, and shares the list with the cloud platform logic. In some cases, the E2 nodes are not updated; instead, the internal cloud platform logic performs load balancing of the E2 nodes such that their requests reach their assigned local near-RT RIC instance. In one or more embodiments of the present invention, the near-RT RIC informs the non-RT RIC on the decisions taken.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

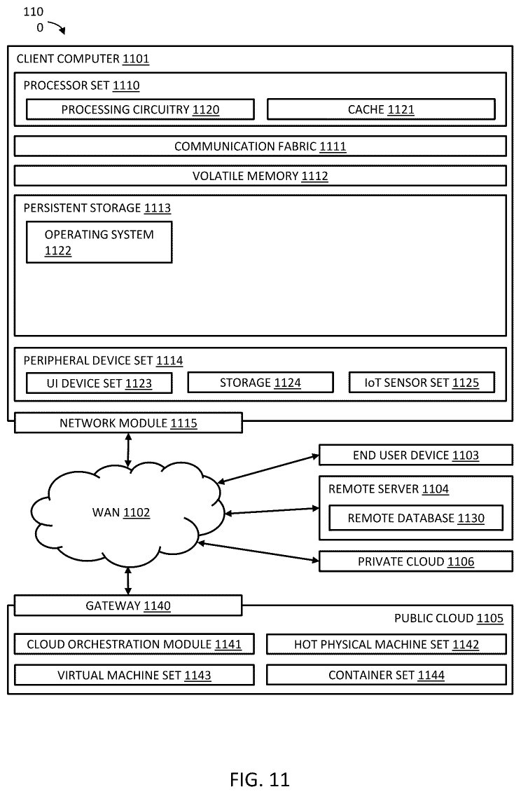

FIG. 11 depicts a computing environment in accordance with one or more embodiments of the present invention. Computing environment 1100 contains an example of an environment for the execution of at least some of the computer code involved in performing the inventive methods, such as optimal compression of machine learning model 800. In addition to block 800, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 800 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 800 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The present invention can be a system, a method, and/or a computer program product at any possible technical detail level of integration. The computer program product can include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions can also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for dynamically reconfiguring a control plane of a radio access network, the computer-implemented method comprising:
generating a self-awareness matrix of a radio access network (RAN) that comprises a plurality of E2 nodes, the self-awareness matrix comprises a plurality of records for each respective E2 node from the plurality of E2 nodes, a first record corresponding to a first E2 node comprises, for the first E2 node, one or more attributes of the control plane of the RAN, the first E2 node being assigned to a first Near-Real-Time RAN Intelligent Controller (near-RT RIC); and
in response to the first record satisfying a predetermined condition based on the one or more attributes of the control plane reconfiguring the control plane of the RAN.

2. The computer-implemented method of claim 1, wherein the one or more attributes of the control plane comprise a transaction load, a latency response, and a distance from a controlling near-RT RIC.

3. The computer-implemented method of claim 1, wherein the first record comprises one or more attributes of a user plane of the RAN for the first E2 node.

4. The computer-implemented method of claim 3, wherein the one or more attributes of the user plane of the RAN comprise a performance key performance index, and a fault data.

5. The computer-implemented method of claim 1, wherein reconfiguring the control plane comprises updating at least one of the E2 nodes by reassigning a near-RT RIC associated with the at least one of the E2 nodes.

6. The computer-implemented method of claim 1, wherein reconfiguring the control plane comprises migrating the first near-RT RIC.

7. The computer-implemented method of claim 1, wherein reconfiguring the control plane comprises instantiating a new near-RT RIC.

8. The computer-implemented method of claim 1, wherein reconfiguring the control plane comprises changing one or more control units (CUs) and/or one or more distributed units (DUs) associated with the first near-RT RIC.

9. A system comprising:
a non-real-time radio access network intelligent controller (non-RT RIC) of a radio access network (RAN);
a plurality of near-real-time RAN intelligent controllers (near-RT RICs) of the RAN, the non-RT RIC controlling one or more operations of the near-RT RICs; and
a plurality of E2 nodes that use the RAN via the near-RT RICs;
wherein the non-RT RIC is configured to perform a method comprising:
generating a self-awareness matrix of the RAN, the self-awareness matrix comprises a plurality of records, each record corresponding respectively to each E2 node from the plurality of E2 nodes, a first record corresponding to a first E2 node comprises, for the first E2 node, one or more attributes of a control plane of the RAN, the first E2 node being assigned to a first near-RT RIC; and
in response to the first record satisfying a predetermined condition based on the one or more attributes of the control plane reconfiguring the control plane of the RAN.

10. The system of claim 9, wherein the one or more attributes of the control plane comprise a transaction load, a latency response, and a distance from a controlling near-RT RIC.

11. The system of claim 9, wherein the first record comprises one or more attributes of a user plane of the RAN for the first E2 node.

12. The system of claim 11, wherein the one or more attributes of the user plane of the RAN comprise a performance key performance index, and a fault data.

13. The system of claim 9, wherein reconfiguring the control plane comprises updating at least one of the E2 nodes by reassigning a near-RT RIC associated with the at least one of the E2 nodes.

14. The system of claim 9, wherein reconfiguring the control plane comprises migrating the first near-RT RIC.

15. The system of claim 9, wherein reconfiguring the control plane comprises instantiating a new near-RT RIC.

16. The system of claim 9, wherein reconfiguring the control plane comprises changing one or more control units (CUs) and/or one or more distributed units (DUs) associated with the first near-RT RIC.

17. A computer program product comprising a memory device with computer-executable instructions therein, the computer-executable instructions when executed by a processing unit perform a method comprising:
generating a self-awareness matrix of a radio access network (RAN) that comprises a plurality of E2 nodes, the self-awareness matrix comprises a plurality of records for each respective E2 node from the plurality of E2 nodes, a first record corresponding to a first E2 node comprises, for the first E2 node, one or more attributes of a control plane of the RAN, the first E2 node being assigned to a first Near-Real-Time RAN Intelligent Controller (near-RT RIC); and
in response to the first record satisfying a predetermined condition based on the one or more attributes of the control plane reconfiguring the control plane of the RAN.

18. The computer program product of claim 17, wherein reconfiguring the control plane comprises updating at least one of the E2 nodes by reassigning a near-RT RIC associated with the at least one of the E2 nodes.

19. The computer program product of claim 17, wherein reconfiguring the control plane comprises migrating the first near-RT RIC.

20. The computer program product of claim 17, wherein reconfiguring the control plane comprises instantiating a new near-RT RIC.
